(19) United States
(12) Patent Application Publication
(10) Pub. No.: US 2008/0193060 A1
(43) Pub. Date: Aug. 14, 2008

(54) Flexible Container Designed to Contain Food Products and Process for Manufacturing the Said Flexible Container

(76) Inventor: Massimo Paradiso, Serradarce (IT)

Correspondence Address: NOTARO AND MICHALOS, 100 DUTCH HILL ROAD, SUITE 110, ORANGEBURG, NY, 10962-2100, US

(21) Appl. No.: 11/632,605

(22) PCT Filed: Jul. 29, 2005
(86) PCT No.: PCT/EP05/08235

§ 371 Date: Jan. 16, 2007

(30) Foreign Application Priority Data
Jul. 29, 2004 (EP) 04425582.6

(51) Int. Cl. B65D 33/16; B65D 33/00; B65D 83/00; B29C 65/08

(52) U.S. Cl. 383/210.1; 383/210; 222/196.1; 156/73.1

(57) ABSTRACT

This invention relates to a flexible container designed to contain food products, particularly in powder and granular form, comprising a plurality of walls (2, 3) joined together by thermal welding, the said walls forming a mouth (4), mouth (4) being associated by thermal welding with a base member (5) and having the feature that the said base member (5) comprises a grating (6) for controlled delivery of the said food products and in that the said base member (5) comprises means capable of providing a removable closure (7) for the said grating (6).

This invention relates to a flexible container designed to contain food products and a process for manufacturing the said flexible container, particularly but not exclusively, a flexible container intended to contain food products in powder and granular form according to claim 1.

Containers of the throwaway type, both rigid or semirigid and flexible, which are designed to contain liquid or paste substances, are commonly used in the large-scale distribution of food products.

For example envelope or sachet flexible containers which are completely heat welded around their perimeters, comprising several layers of flexible materials and designed to contain food products, are known.

Containers for food products comprising a single sheet of plastics material wrapped around the product are also known. Such sheets are heat welded at the two opposite edges to form a kind of tubular envelope to enclose the product.

Although satisfactory from many points of view, these containers have a disadvantage associated with the operation of opening them.

In fact the container becomes torn when the consumer opens these containers.

This compromises the possibility of reclosing the container and this means that the product has to be consumed within quite a short period of time, otherwise the product's organoleptic qualities will deteriorate.

Another type of throwaway container for liquids and paste substances which has recently become widely used and is favoured by users comprises a flexible sachet made of layered film provided with a rigid delivery spout closed off by a screw cap, generally provided with a sealing collar.

When screwed externally onto the spout the cap provides effective hygienic protection for the end of the spout.

This type of container, although it permits easier and immediate use of the contents, is not however without disadvantages.

The operation of closing the container in the filling and sealing process requires the use of relatively complex machinery for screwing on the cap with a controlled tightening torque and gives rise to a fixed plant cost which adds to that of moulding the screw cap, not negligibly affecting the overall cost of manufacturing the product, in particular for single dose packs, where the function of the screw cap is to protect and preserve the product only up to the time of use.

The above-mentioned containers also have the disadvantage that they may incorporate microholes which might prejudice conservation of the product. The presence of microholes is, for example, caused by localised stresses which arise when the container is filled with product, or these microholes derive from an imperfect operation of thermally welding the rigid spout to the edge of the flexible sachet.

The object of this invention is to provide a sealed flexible container designed to contain food products.

A further object of this invention is to provide a container capable of controlled release of the product contained within it.

This object is accomplished through a flexible container designed to contain food products, particularly in powder and granulated form, according to claim 1.

Through this invention it is possible to provide a low-cost flexible container which is simple to manufacture and more readily usable and hygienically protected than known containers.

Further features and advantages of the flexible container designed to contain food products, particularly in powder or granulated form, according to this invention will be apparent from the description provided below of a preferred embodiment thereof provided merely indicatively and without restriction with reference to the appended figures, in which:

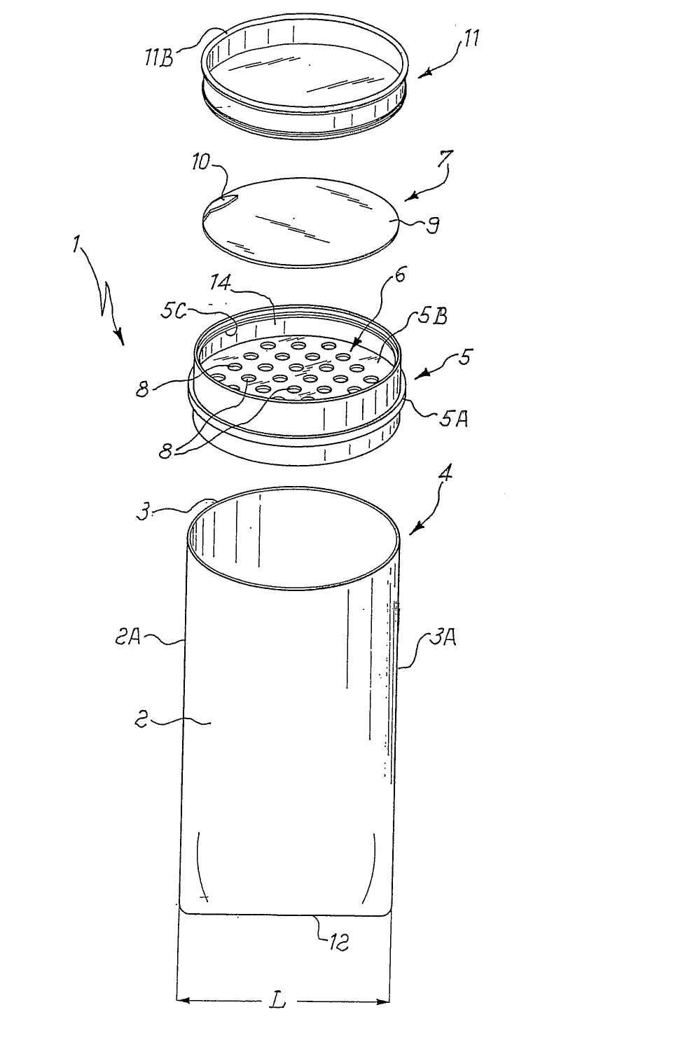

FIG. 1 shows an exploded view of the container according to this invention,

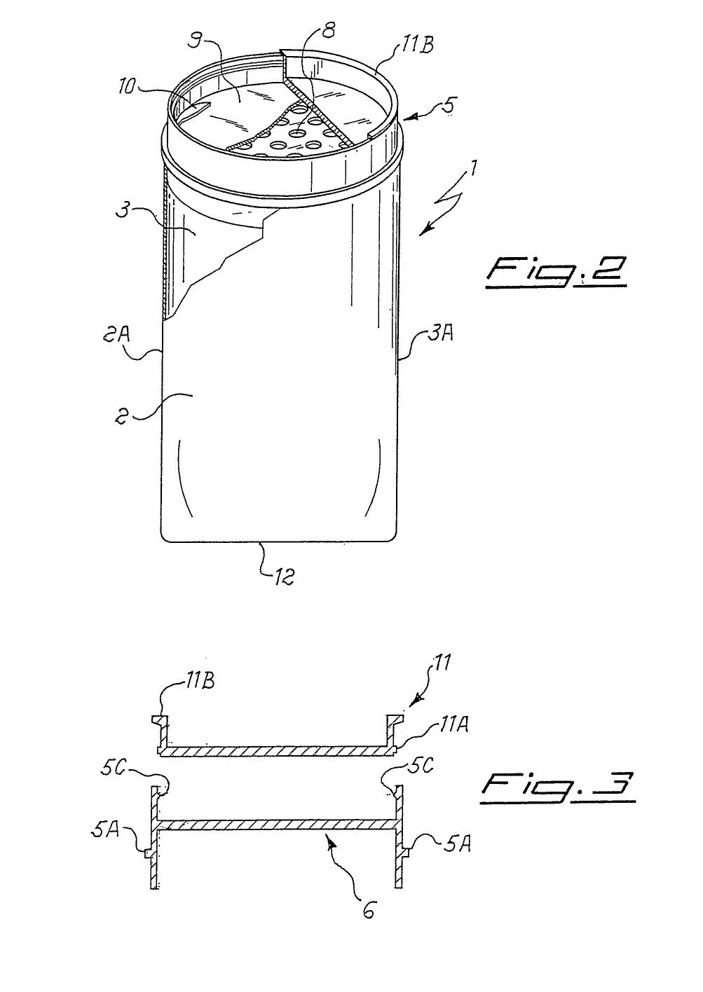

FIG. 2 is a perspective view of the container according to this invention,

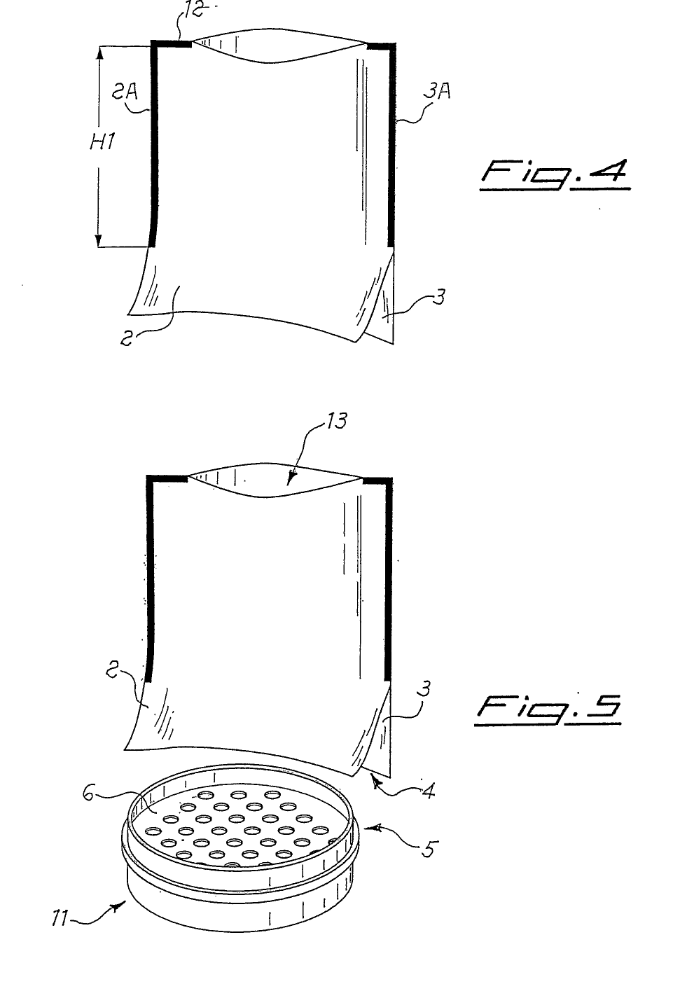

FIG. 3 shows a view in cross-section of two components of the container according to this invention,

FIGS. 4-7 show diagrammatically the stages in the process for manufacturing the container according to this invention.

With reference to the appended figures, 1 indicates as a whole a flexible container designed to contain food products, particularly in powder and granulated form.

Container 1 comprises a plurality of walls 2 and 3 which are joined together by thermal welding. Walls 2 and 3 form a spout 4 which is associated by thermal welding with a base member 5.

Base member 5 comprises a grating 6 for controlled delivery of the food product contained in container 1 and means to effect removable closure 7 of said grating 6.

In particular grating 6 comprises a member of discoidal shape having a plurality of holes 8 through which the food product can pass.

The means for providing removable closure 7 for said grating 6 comprises a membrane seal 9 provided with at least one graspable tongue 10 and a closing cap 11 capable of forming an interference coupling with said base member 5.

In an embodiment not illustrated in the figures, the plurality of walls 2 and 3 take the form of a pair of anterior and posterior sheets of stratified material placed together and two lateral pieces folded in the manner of bellows and placed between the two anterior and posterior sheets. The two sheets and the lateral pieces are heat welded together at the periphery so that once filled the container adopts an envelope shape.

According to a particular embodiment of the invention plurality of walls 2 and 3 of container 1 comprises two flat sheets (or a single folded sheet) heat welded together along longitudinal edges 2A and 3A and along a transverse edge 12.

The lower ends of walls 2 and 3 are associated with base member 5 through a heat welding operation performed with a hot iron of annular shape, or by ultrasound or induction, that is walls 2 and 3 are joined to base member 5 by exerting a pressure force with the provision of heat.

With this object base member 5 comprises a shoulder 5A against which the lower ends of walls 2 and 3 abut.

Base member 5 may be of substantially discoidal shape or in any event a shape comprising of curved sections connected together. In the particular embodiment base member 5 takes the form of a member having an elliptical transverse cross-section. The material of which this base member 5 is manufactured is for example a thermoplastic material. This thermoplastic material can be moulded and may for example be polyethylene.

Obviously the use of base member 5 of elliptical shape is only preferred, mainly for aesthetic reasons; there is nothing to prevent the use of base members having a circular or polygonal shape as a base member.

As will be seen from the appended figures, base member 5 has a transverse dimension which is substantially equal to the width L of container 1, for example a length of approximately 10 cm.

Walls 2 and 3 of container 1 may be manufactured from a material of the stratified type.

For example a stratified material commonly used for the manufacture of walls 2 and 3 comprises a film of polyester (PET) applied externally to a sheet of aluminium (Al) covered with a film of polyethylene (PE) on the inside, with the possible interposition of a nylon (N) coupling film.

It should be noted that the material forming walls 2 and 3 must be a material compatible with the material forming base member 5; by the term compatible is meant the possibility that one of the aforesaid materials comprising walls 2 and 3 can be caused to adhere to the thermoplastic material comprising bottom member 5 through the action of heat (with or without a simultaneous pressing force).

For example, if base member 5 comprises polyethylene, walls 2 and 3 will be made of polyethylene, and if base member 5 is of polypropylene the aforesaid walls 2 and 3 will also be of polypropylene.

A welding material having a low plasticisation point such as for example a material comprising a polyethylene film is usually used to carry out the thermal welding operation between the walls.

Through this arrangement a container 1 is obtained in which base member 5 and the overlying part (that is the container) comprise a single whole, without any break in continuity, which confers the desired characteristic of a hermetic seal.

As previously stated, base member 5 comprises a grating 6 having a plurality of holes 8 through which the food product can pass; grating 6 can be closed through membrane seal 9.

In fact membrane seal 9 extends over the whole surface area of grating 6, that is it covers the plurality of holes 8, preventing release of product.

Advantageously, membrane seal 9, which is pressed by commonplace mechanical devices onto grating 6, is welded thereto by heat (with a hot iron, ultrasound or induction) in order to ensure a perfect bond between seal 9 and grating 6.

For example, seal 9 comprises a stratified laminate sheet comprising essentially an outer layer of polyester (which might be moulded internally) which provides the necessary mechanical strength to prevent tearing, an intermediate layer of aluminium or a layer of high-bonding varnish or plastic film which is coupled to outer surface 5B of base member 5.

Indicatively the aluminium layer may have a thickness of 40 μm, the polyester layer a thickness of 12 μm and the layer of varnish a thickness of 5 μm.

Membrane seal 9 is therefore associated with outer surface 5B of end member 5, thus ensuring effective hygienic protection of the product contained in container 1.

As will be seen from the appended figures, membrane seal 9 is provided with tongue 10 to permit opening and closing of grating 6 of container 1.

This tongue 10 lies outside the weld to provide the user with a convenient and particularly robust grip.

Through tongue 10 it is possible to perform the so-called operation of peeling open grating 6, that is to allow the controlled release of product contained in container 1 through holes 8.

Membrane seal 9 is therefore a warranty seal, the removal of which shows that container 1 has been opened.

Still with reference to the appended figures, it will be noted that base member 5 can be associated with cap 11 forming an interference coupling. This coupling takes the form for example of a snap coupling. With this object base member 5 has a peripheral ring 5C on the inner surface of shoulder 14 to engage a corresponding peripheral ring 11A in cap 11.

This cap 11 therefore brings about closure of holes 8 once membrane seal 9 has been removed by the user, so as to prevent escape of the product contained in container 1.

Cap 11 advantageously comprises a circular crown 11B through which it is possible to ensure that container 1 is vertical when this is placed on a substantially horizontal surface.

In other words, cap 11 performs both the function of a closure member for holes 8 of grating 6 once seal 9 has been removed, and a supporting member for container 1.

Cap 11 may for example be manufactured from polyethylene.

Obviously a person skilled in the art may provide other structurally and/or functionally equivalent forms of engagement to replace the aforesaid snap engagement between cap 11 and base member 5.

In use, in order to control the quantity of product which has to be delivered, the user first removes cap 11 so as to expose membrane seal 9. Then the user exerts a pulling force through tongue 10 such as to effect complete removal of such membrane seal 9 from surface 5B of base member 5. Finally, applying pressure on walls 2 and 3 or by shaking container 1 the user causes the food product contained in the container to escape through holes 8 of grating 6.

Once the product has been delivered, the user reseals container 1 by placing cap 11 on holes 8 of grating 6 of base member 5.

The stages for manufacturing container 1 designed to contain food products, particularly in powder and granular form, according to the process according to the invention are illustrated diagrammatically with reference in particular to FIGS. 4-7.

FIG. 4 shows a first stage in the operation of sealing container 1 through a heat welding operation (shown in the figure by a thick line). This operation consists of carrying out a heat welding operation along longitudinal edges 2A and 3A of corresponding walls 2 and 3 and along their transverse upper edge 12.

In particular the portion of the longitudinal edges which are heat welded together in this first stage provides that only a length H1 of said longitudinal edges 2A and 3A is effectively heat welded, so as to form mouth 4.

Length H1 lies within a range varying between 60% and 80% of the height H of longitudinal edges 2A and 3A. Preferably length H1 is equal to 75% of the height H of said edges 2A and 3A.

The operation of heat welding transverse edge 12, or the edge opposite that in which mouth 4 is formed, makes it possible to form a further mouth 13. In other words the heat welding operation only takes place along a portion of transverse edge 12.

FIG. 5 shows the second stage during which base member 5 is associated with mouth 4 by thermal welding. At the time of association with walls 2 and 3 base member 5 is already provided with means 7 to permit removable closure of grating 6 in addition to said grating 6.

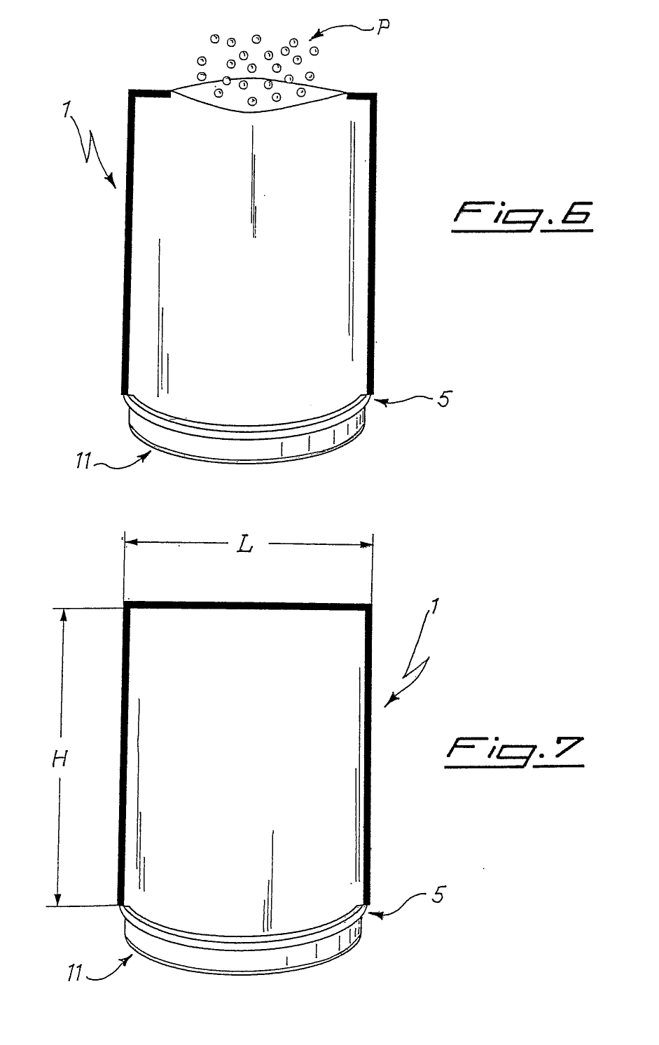

Subsequently, with reference to FIGS. 6-7, product P is introduced through second mouth 13 and finally container 1 is sealed, completing the operation of heat welding upper transverse edge 12.

In order to satisfy contingent and specific requirements a person skilled in the art could apply many modifications and adaptations and the replacement of members with other functional equivalent members to the preferred embodiment of the invention described above without however going beyond the scope of the following claims.

1-13. (canceled)

14. Flexible container designed to contain food products, particularly in powder and granulate form, comprising:
a plurality of walls joined together by thermal welding, the said walls forming a mouth,
said mouth being associated by heat welding with a base member,
said base member comprising a grating for controlled delivery of the food product and means able of forming a removable closure for said grating,
wherein said means able of providing a removable closure for said grating comprise a closing cap able of forming an interference coupling with the said base member.

15. Flexible container according to claim 14, wherein that said base member has a discoidal perimeter.

16. Flexible container according to claim 14, wherein said base member has an elliptical transverse cross-section.

17. Flexible container according to claim 14, wherein said delivery grating comprises a plurality of holes through which the said food products pass.

18. Flexible container according to claim 14, wherein said means able of providing a removable closure for said grating comprise a membrane seal.

19. Flexible container according to claim 18, wherein said membrane seal comprises a tongue which can be grasped.

20. Flexible container according to claim 18, wherein said membrane seal fully covers the said grating.

21. Flexible container according to claim 18, wherein said membrane seal is formed of stratified material.

22. Flexible container according to claim 21, wherein said closure cap is formed from thermoplastic material.

23. Flexible container according to claim 14, wherein said plurality of walls are two walls connected to each other at their lateral edges by thermal welding, said two walls being associated beneath with the said base member by thermal welding.

24. Flexible container according to claim 14, wherein said plurality of walls are made of stratified material.

25. Process for manufacturing a flexible container designed to contain food products, particularly in powder and granular form, the process comprises the steps of:
placing two sheets made of stratified material together,
heat welding said two sheets longitudinally over a first length such as to form a first mouth,
heat welding a portion of an edge of the said two sheets together transversely in order to form a second mouth,
associating a base member comprising a grating provided with a plurality of holes and means to provide a removable closure for said grating with the said first mouth by thermal welding, and
thermally welding said two sheets longitudinally by heat welding over the remaining length as far as a perimetral shoulder of the said base member.

26. Process according to claim 25, wherein it comprises the further steps of:
filling the said container with a food product through the said second mouth,
heat welding the said edge of the said two sheets together transversely so as to seal the said container.
